(19) United States
(12) Patent Application Publication
(10) Pub. No.: US 2009/0280743 A1
(43) Pub. Date: Nov. 12, 2009

(54) DEVICE FOR THE WIRELESS TRANSMISSION OF SIGNALS BETWEEN TWO PARTS OF A PROCESSING MACHINE

(75) Inventors: Stephan Gast, Schwabsoien (DE); Josef Greif, Friesenried (DE); Stefan Bonerz, Kaufbeuren (DE); Markus Fuhrmann, Fussen (DE); Winfried Horger, Stotten am Auerberg (DE)

Correspondence Address: Fleit Gibbons Gutman Bongini & Bianco PL, 21355 EAST DIXIE HIGHWAY, SUITE 115, MIAMI, FL, 33180, US

(73) Assignee: OTT-JAKOB SPANNTECHNIK GMBH, Lengenwang (DE)

(21) Appl. No.: 12/400,498

(22) Filed: Mar. 9, 2009

(30) Foreign Application Priority Data
May 10, 2008 (DE) 10 2008 023 224.6

(51) Int. Cl. H04B 7/00

(52) U.S. Cl. 455/41.2; 455/66.1

(57) ABSTRACT

In a device for wireless transmission of signals between two parts (17, 23) of a processing machine, wherein, when the processing machine is operating, one of these parts rotates relative to the other part about an axis (18), several antennas (8A, 8B, 8C; 108A, 108B, 108C; 13A, 13B, 13C) are arranged on at least one of the two parts (17, 23) in an at least approximately regular distribution with respect to the peripheral direction of rotation. The antennas (8A, 8B, 8C; 108A, 108B, 108C; 13A, 13B, 13C) are connected in parallel to a transmit device (7) and/or receive device (12) allocated to each part (17, 23). The lengths of the individual antennas (8A, 8B, 8C) overlap in the peripheral direction of rotation, and the antennas are arranged at least partially offset radially and/or in the longitudinal direction of the rotational axis (18). Phase-shifted signals are fed to the individual antennas (108A, 108B, 108C) by the transmit device, and/or signals received by the antennas (13A, 13B, 13C) are superimposed with a phase shift by the receive device.

### CROSS REFERENCE TO RELATED APPLICATION

This application claims priority under 35 U.S.C. § 119 to German Patent Application No. 10 2008 023 224.6 filed May 10, 2008, the entire contents of which are incorporated herein by reference.

### FIELD OF THE INVENTION

The invention relates to a device for the wireless transmission of signals.

### BACKGROUND OF THE INVENTION

Such a device is known from DE 20 2004 016 751 A1, which describes the optimization of inductively coupled transponder systems for the field of machine and system construction. For the use of such transponder systems in metallic surroundings, it proposes the use of highly permeable materials that prevent the penetration of the magnetic field lines in the metal and guarantee operation in these environmental conditions.

In radio transponder systems with a rotational movement between the transmitter and receiver, the emission or reception characteristics of each antenna on the rotor and/or the stator essentially determine the quality of the data transmission. Here, a transmission and reception quality that is as constant as possible at each angular position is desired. A suboptimal transmission and/or reception quality leads directly to an increase in the error rate in the data transmission.

Thus, for example, a wire loop that is adapted to the transmission or reception frequency and also the original geometric conditions and that runs in the peripheral direction of the rotor or the stator generates one or more emission or reception minima along its peripheral direction. Due to the rotational movement of the rotor, this leads to a strong amplitude modulation that has a direct effect on the ability to reconstruct data on the receive side. The same also applies analogously for dipole antennas. Here, the spatial emission or reception characteristics also have minima that adversely affect the transmission quality.

Commercially available radio reception components have a variable amplifier in the antenna input region whose amplification factor is matched to the received signal by means of a control loop. This control has a transient response that has an interfering effect on the data transmission at higher rotational speeds, so that in many cases reception is not possible, or is only possible with a high error rate. In such a case, the error rate can indeed be reduced through the use of coding methods that allow error recognition (e.g., CRC check), and also through multiple data transmissions, i.e., through multiple transmissions of the individual data words to be transmitted. However, this leads to a reduction in the effective data transmission rate, which is undesired in many fields of application.

Commercially available transmission and reception antennas are not designed for use in rotationally symmetric structures. Indeed, in such antennas, in principle, a rotationally symmetric characteristic is given, but the antenna would have to be mounted in the axial direction and simultaneously an open line of sight to the corresponding counter antenna would have to be given, so that the rotationally symmetric characteristic would have an effect. However, this is not possible due to the construction, because the rotor electronics must always be mounted on the periphery of a shaft, so that an open line of sight in the axial direction is not given.

A solution would be conceivable in which the current angular position relative to a reference position is measured continuously by means of suitable sensors on the rotor, and the data transmission is always performed only in a limited angular segment in which a good transmission quality is guaranteed. Thus, the use of commercially available antennas would indeed be possible, but this solution has the disadvantages of high costs for detecting and processing the angular position of the rotor and also a forced reduction in the achievable data rate.

### SUMMARY OF THE INVENTION

The problem of the invention is therefore to devise an antenna arrangement for a device according to the class that allows interference-free data transmission at a high data rate.

This problem is solved according to the invention by a device with the features of Claim 1. Advantageous configurations are specified in the subordinate claims.

The invention is based on the combination of a plurality of antennas, none of which in itself has the desired radially symmetric emission or reception characteristics with respect to the two machine parts to be connected by a wireless transmission path, but when they are connected together and suitably excited on the transmit side or when individual signals are suitably superimposed on the receive side, these antennas have individual characteristics that generate approximately radially symmetric overall transmission characteristics. Here, in principle, the use of such an antenna combination either on the transmit side or on the receive side is suitable, but the effect can be increased through use on both sides.

A first preferred variant of the realization consists in a corresponding spatial superposition of individual antennas in the peripheral direction of the rotation. For suitable selection of the relative offset of the individual antennas in the stated peripheral direction through a corresponding superposition of the individual transmission characteristics, such overlapping leads to overall characteristics with significantly less strongly pronounced extremes.

A second preferred variant of the realization consists in a phase-shifted excitation of several transmit antennas according to the sequence in the peripheral direction of rotation and/or corresponding phase-shifted superposition of the receive signals of several receive antennas.

Other advantageous configurations of the invention can be taken from the subordinate claims.

### BRIEF DESCRIPTION OF THE DRAWINGS

Embodiments of the invention will be described below with reference to the drawings. Shown in these drawings are:

FIG. 1, a block circuit diagram of a wireless sensor system for a processing machine,

FIG. 2, a longitudinal sectional view of parts of a processing machine equipped with a wireless sensor system,

FIG. 3, a block circuit diagram of a first antenna arrangement according to the invention,

FIG. 4, a schematic axial view of the antenna arrangement according to FIG. 3,

FIG. 5, the interconnection of the antenna arrangements according to FIGS. 3 and 4,

FIG. 6, a block circuit diagram of a second antenna arrangement according to the invention,

FIG. 7, a schematic axial view of the antenna arrangement according to FIG. 6,

FIG. 8, a schematic axial view of a third antenna arrangement according to the invention in connection with an emission diagram of an individual antenna,

FIG. 9, the time profiles of the received powers of the individual antennas from FIG. 8,

FIG. 10, the time profile of the superposition of the received powers from FIG. 9.

### DETAILED DESCRIPTION OF THE INVENTION

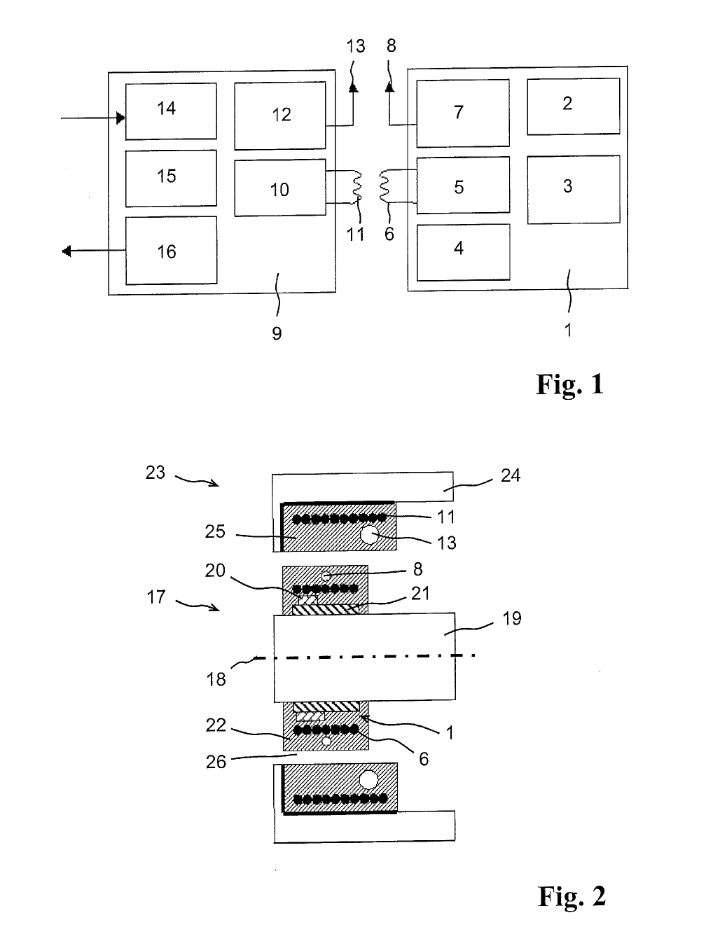

In modern automatic processing machines, there is a trend toward the use of wireless sensor systems for detecting the profile of operating parameters, such as force, torque, and temperature values. FIG. 1 shows a block circuit diagram of such a sensor system. Here, the rotor electronics 1 are located on a part, called “rotor” below, that rotates when the machine is in operation. As essential functional units, these electronics include one or more sensors 2, e.g., resistance strain gauges, a sensor signal processor 3, a microcontroller 4, a power converter 5 with a secondary coil 6 for the inductive supply of other units with electrical power, and a radio module 7 with an antenna 8 for the external communications, in particular, the transmission of detected measurement data.

The stator electronics 9 are located on the stationary part of the machine, called stator below. As essential function units, these electronics include a power converter 10 for the inductive delivery of electrical power to rotor electronics 1 via a primary coil 11, a radio module 12 with an antenna 13 for communications with the rotor electronics 1, a power converter 14 for receiving electrical power from a power supply (not shown) of the machine, a microcontroller 15, and also an interface 16 for forwarding the data measured by the sensor 2 and transmitted to the stator electronics 9 to a higher-level machine controller.

The sensor system is based on known transponder technology, where the power is inductively coupled to the rotor electronics 1, for example, at a frequency on the order of 30 kHz, and the received measurement data is transmitted to the stator electronics 9 by radio, for example, at a frequency on the order of 2.4 GHz or in a different ISM band.

A longitudinal section view of parts of a processing machine equipped with such a wireless sensor system is to be seen in FIG. 2. When the machine is operating, the rotor 17 rotates about an axis 18. It includes a cylindrical shaft or spindle 19 made from metal on which the rotor electronics 1 are mounted. The components 20 are built on a flexible substrate 21 that is guided around the spindle 19 in the peripheral direction and surrounded by the secondary coil 6 that has an axis coinciding with the axis 18 of the spindle 19. The antenna 8 of the rotor electronics 1 forms the radially outermost element of the rotor electronics 1 that are embedded as a whole in an inner carrier body 22 made from plastic and rigidly connected to the spindle 19.

The stator 23 includes a mechanical machine element 24 that is made from metal. A plastic outer carrier body 25 in the form of a hollow cylinder is rigidly attached to the inside of this machine element. Between the inner carrier body 22 and the outer carrier body 25 there is an air gap 26 of constant width along the periphery. The primary coil 11 and the antenna 13 of the stator electronics 9 are embedded in the outer carrier body 25, with the antenna 13 being arranged farther to the inside in the radial direction than the primary coil 11. The other components of the stator electronics 9 not shown in FIG. 2 can also be arranged directly on the stator 23, for example, embedded in the outer carrier body 25, but can also be placed elsewhere on the machine, away from the stator 23. When the machine is operated, the rotor 17 is shifted by a predetermined amount relative to the stator 23 in the longitudinal direction of the axis 18. However, the previously described rotational symmetry of the arrangement of the rotor 17 and stator 23 with respect to the axis 18 remains intact.

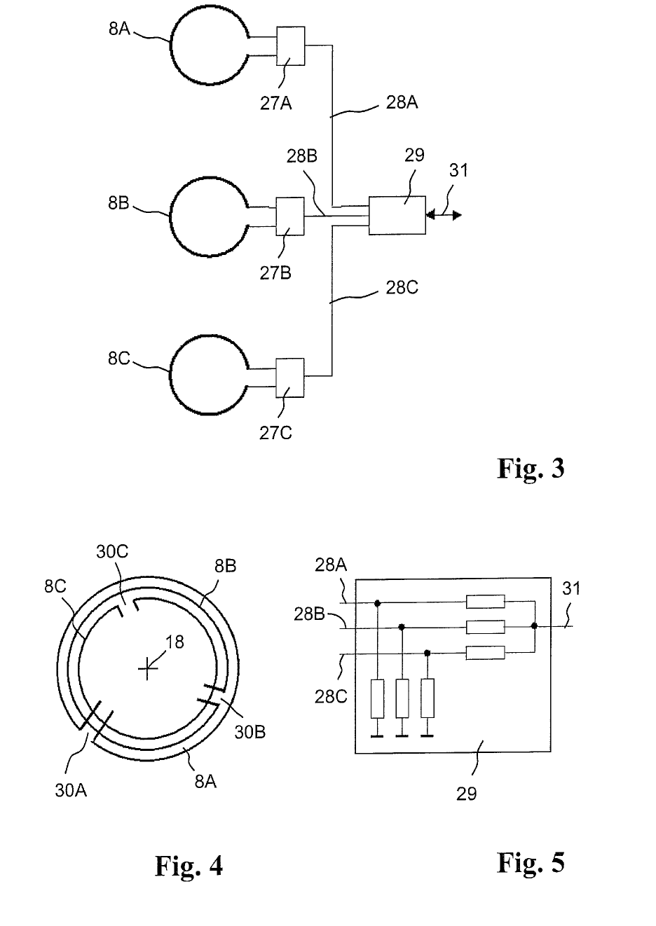

FIG. 3 shows a first antenna arrangement that implements the present invention in the form of a block circuit diagram. Below, it is initially assumed that it involves a transmit-side antenna arrangement. As to be seen from FIG. 3, three different equivalent loop antennas 8A, 8B, and 8C are provided. Each is connected to a common branching element 29 by means of a respective matching element 27A, 27B, or 27C and a supply line 28A, 28B, or 28C. The matching elements 27A, 27B, and 27C involve known, so-called balanced-unbalanced transformers for matching the symmetric loop antennas 8A, 8B, and 8C to the asymmetric supply lines 28A, 28B, or 28C in the interest of simplifying the signal processing.

One special feature according to the invention lies in the geometric arrangement of the three loop antennas 8A, 8B, and 8C, wherein this arrangement is shown schematically in FIG. 4. The three loop elements 8A, 8B, and 8C are arranged radially and concentric to the axis 18. Their bases 30A, 30B, and 30C, at which they are each angled radially, are successively offset relative to each other each by 120°. The other components shown in FIGS. 2 and 3 are left out of FIG. 4 for the sake of clarity. The arrangement according to FIG. 4 is regular and symmetric in the peripheral direction with respect to the positions of the bases 30A, 30B, and 30C. Instead of having different diameters, the loop antennas 8A, 8B, and 8C could also be offset relative to each other with the same diameter in the longitudinal direction of the axis 18. Here it is essential that the difference in diameter that can be seen in FIG. 4 or the alternatively possible offset in the longitudinal direction of the axis 18 is small relative to the average diameter, so that it does not significantly affect the emission characteristics, that is, all three loop antennas 8A, 8B, and 8C have essentially the same emission characteristics apart from the different positions of the bases 30A, 30B, and 30C.

Consequently, in an arrangement like that of FIG. 4, because the base 30A, 30B, and 30C of each loop antenna 8A, 8B, and 8C is covered by the two other loop antennas, the minimum in the radial emission characteristics in the plane of the drawing at each stated base 30A, 30B, and 30C is largely equalized by the emission characteristics of the two other loop antennas, so that significantly more uniform overall radial characteristics of the emissions are produced.

It can also be useful to not always select the same values for the angle offsets between successive antennas, but instead to provide select deviations, in order to compensate for irregularities in the emission field that generate irregularities in the shape of the metallic surroundings, for example, in the shape of boreholes.

For the sake of completeness, FIG. 5 shows the interconnection of the individual supply lines 28A, 28B, and 28C in the branching element 29. As is to be seen from this figure, these supply lines 28A, 28B, and 28C are connected via first resistors to ground and via second resistors to a common star point 31 to which the common data signal to be emitted from the loop antennas 8A, 8B, and 8C is coupled.

Concerning the supply lines 28A, 28B, and 28C, it is also to be noted that these may not have significantly different lengths compared to the schematic diagram in FIG. 3, because the resulting differences in propagation time would cause undesired phase shifts between the radio signals emitted by the individual antennas 8A, 8B, and 8C. Thus, an equalization of length or propagation time must be provided.

The above description relates to the transmit side of the transmission path. However, the invention can also be applied just as well to the receive side. In this case, the individual antennas 8A, 8B, and 8C would involve receive antennas. However, on the receive side, nothing would change apart from the direction of signal flow in the interconnection of the antennas 8A, 8B, and 8C according to FIGS. 3 and 5, and also in their geometric arrangement relative to each other according to FIG. 4. At the star point 31 of the branching element 29, in this case a signal would be output for further processing instead of supplied for emission. For the use of loop antennas 8A, 8B, and 8C, in the region of each base there are then minima of the radial reception characteristics that would be largely equalized, in turn, through the overlapping and the regular symmetric angular offset of the individual antennas.

Obviously, a simultaneous application of this embodiment of the invention is possible both on the transmit side and on the receive side. It is understood that the equalizing effect of the invention more strongly affects the transmission characteristics the greater the number of different individual antennas used. Because the number of antennas that could be provided on each of the two sides is limited by the available space, it can even be especially sensible to provide several antennas both on the transmit side and also on the receive side.

It is to be noted that, in the configuration for which the invention is designed, the distance between the transmitter and receiver is very small, so that for the spatial emission or reception characteristics of the antennas, the near field is decisive, and not the far field. The field profile is also considerably influenced by the metallic surroundings (spindle 19, machine element 24), i.e., their reflective behavior, which must absolutely be taken into account for the exact dimensioning of the antenna arrangement.

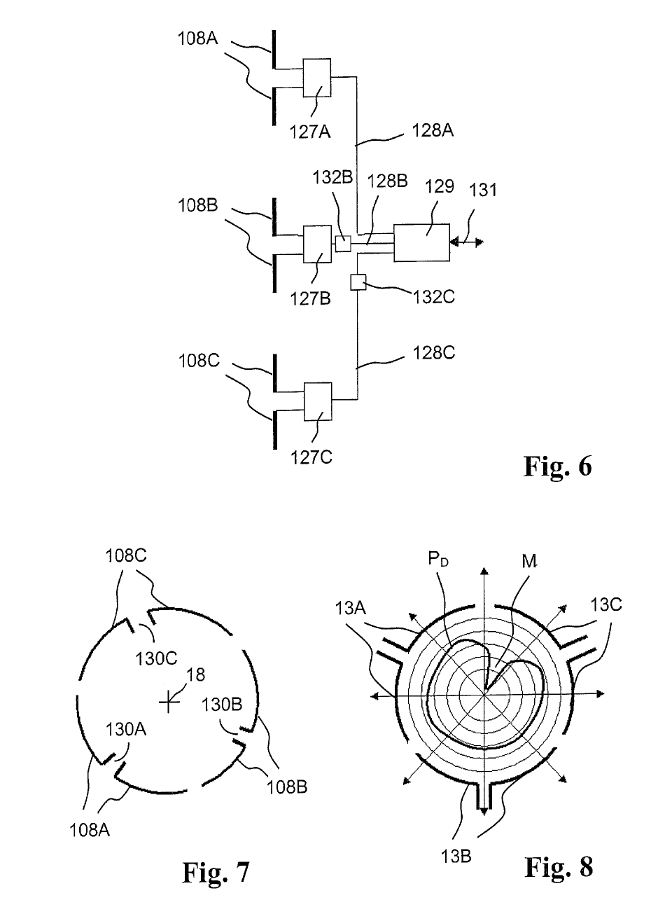

FIG. 6 shows a second antenna arrangement that implements the present invention in the form of a block circuit diagram. Here, it is also initially assumed below that this arrangement involves a transmit-side antenna arrangement. As to be seen from FIG. 6, three different, equivalent dipole antennas 108A, 108B, and 108C are provided. Each is connected by means of a respective matching element 127A, 127B, or 127C and a supply line 128A, 128B, or 128C to a common branching element 129 that is configured like the branching element 29 shown in FIG. 5. Here, the matching elements 127A, 127B, and 127C also involve balanced-unbalanced transformers for matching the symmetric dipole antennas 108A, 108B, and 108C to the asymmetric supply lines 128A, 128B, and 128C in the interest of simplifying the signal processing.

A first special feature according to the invention lies in the arrangement of delay elements 132B and 132C, for example, in the form of delay lines in the respective supply lines 128B and 128C. The individual dipole antennas 108A, 108B, and 108C thus indeed receive the same signal for emission, not in phase, but instead with a defined, mutual phase shift that amounts to 120° successively, i.e., equal to 120° for the antenna 108B relative to the antenna 108A and equal to 240° for the antenna 108C relative to the antenna 108A. It can also be sensible for the phase shift between successive antennas to not always be selected as the same value, but instead to provide select deviations, in order thereby to equalize irregularities in the radiation field that generate irregularities in the shape of the metallic surroundings, for example, in the shape of boreholes.

Another special feature according to the invention lies in the geometric arrangement of the three equivalent dipole antennas 108A, 108B, and 108C shown schematically in FIG. 7. The three dipole antennas 108A, 108B, and 108C are arranged one next to the other on a circle running around the axis 18 of the spindle 19 (FIG. 2) as the center and each successively offset in the peripheral direction by an angle of 120°, so that each of the dipole antennas 108A, 108B, and 108C covers a sector of approximately 120°. Consequently, each of the bases 130A, 130B, and 130C, at which the dipole antennas 108A, 108B, and 108C are each angled radially, are successively offset relative to each other by an angle of 120°. The other components shown in FIGS. 2 and 6 are left out of FIG. 7, in turn, for the sake of clarity. The arrangement according to FIG. 7 is regular and symmetric in the peripheral direction.

Due to the phase shifts caused by the delay elements 132B and 132C between the signals emitted by the antennas 108A, 108B, and 108C, the superposition of these signals produces a significant equalization of the minima of the radial emission characteristics of each individual dipole antenna 108A, 108B, and 108C, so that approximately uniform, overall radial emission characteristics are produced.

The above description relates to the transmit side of the transmission path. This embodiment of the invention can also be applied just as well to the receive side. In this case, the individual antennas would involve receive antennas. However, on the receive side, apart from the direction of signal flow, nothing would change in the interconnection of the antennas according to FIGS. 5 and 6, nor in their geometric arrangement relative to each other according to FIG. 7. In this case, the delay elements 132B and 132C would generate phase shifts of the signals received by the antennas 108B and 108C. The application of the second embodiment of the invention on the receive side will be explained in greater detail below with reference to FIGS. 8-10.

FIG. 8 shows, as an example, a symmetric, circular arrangement of three dipole antennas 13A, 13B, and 13C that involve receive antennas. In the interior of the antenna arrangement, a typical radial emission diagram for an individual dipole antenna is shown. Here, in the radial direction, the power density PD is specified as a function of direction. The shown profile PD that is valid for a specific angular position of the dipole has a pronounced minimum M. It is now assumed that a single dipole antenna is provided, with the shown emission characteristics PD, as a single transmit antenna on the rotor 17 and that the three dipole antennas 13A, 13B, and 13C are provided as receive antennas on the stator 23, wherein the latter are also connected like the dipole antennas 108A, 108B, and 108C in FIG. 6 and merely the direction of signal flow is reversed.

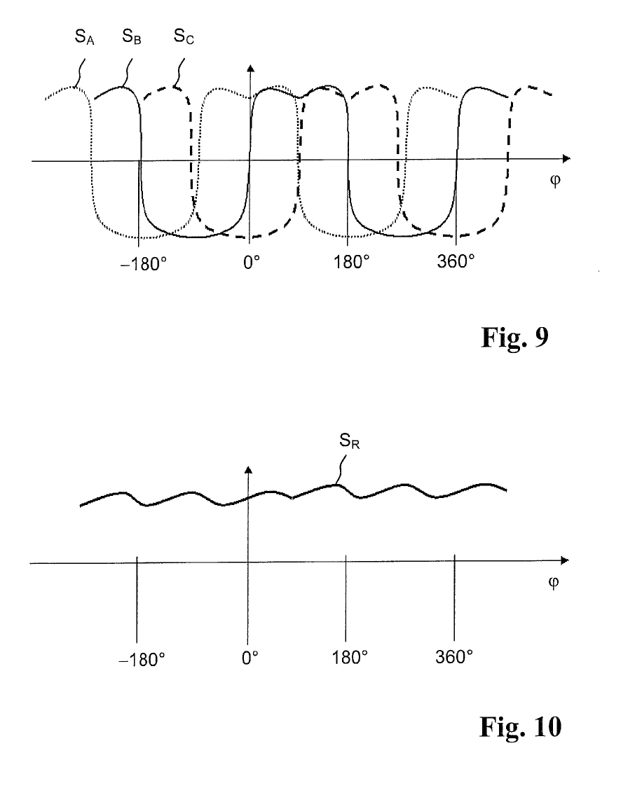

FIG. 9 shows the profile of the signal strengths S_{A}, S_{B}, and S_{C}of the receive signals of the three receive antennas 13A, 13B, and 13C as a function of the angle of rotation φ of the dipole provided as a transmit antenna. Pronounced maxima and minima are to be seen, wherein the position of the abscissa in FIG. 9 was selected randomly and no zero line is shown. If the three receive signals S_{A}, S_{B}, and S_{C} are each added with a successive phase shift of 120° using a delay element of the type in FIG. 5, then, qualitatively, the profile shown in FIG. 10 of the resulting signal strength SR versus the angle of rotation φ of the transmit antenna is produced. Such a signal profile would be output at the star point 131 of the circuit according to FIG. 6 if the transmit antennas 108A, 108B, and 108C there were to be replaced by the receive antennas 13A, 13B, and 13C. The profile of SR indeed still has a slight ripple, but is much more uniform than each of the individual profiles of S_{A}, S_{B}, and S_{C}.

Obviously, in the second embodiment, a simultaneous application of the invention both on the transmit side and also on the receive side is also possible. It is understood that also here the equalizing effect of the invention on the transmission characteristics becomes more pronounced the greater the number of different individual antennas used. For spatial reasons, here it can also be sensible to provide several antennas both on the transmit side and also on the receive side. The above comments on the decisiveness of the near field and on the influence of the reflective behavior of the metallic surroundings also apply to the second embodiment of the invention as well as to the first.

From the above description, for someone skilled in the art, different possibilities are produced for modifications to the invention. For example, the overlap in the peripheral direction does not equal approximately 360° like in the loop antennas of the first embodiment, but instead an overlapping arrangement of other antenna shapes can also be provided, such as, e.g., of dipoles in which the measure of overlap can be significantly smaller. Furthermore, the two embodiments explained here can also be combined with each other, i.e., for an overlapping arrangement it can also be useful to provide a phase shift of the signals. The number of three antennas provided in the embodiments is obviously meant purely as an example and can be varied according to the requirements and initial conditions (space relationships, costs) of the individual application. The communications between the rotor electronics 1 and the stator electronics 9 can also be bidirectional, for example, for activating certain functions of the rotor electronics 1, such as a self-test of the sensor 2, from the stator electronics 9.

1. Device for wireless transmission of signals between two parts of a processing machine, wherein, when the processing machine is operating, one of these parts rotates relative to the other about an axis, and wherein several antennas are arranged on at least one of the two parts in an at least approximately regular distribution with respect to the peripheral direction of the rotation, and that the antennas are connected in parallel to a transmit device and/or receive device allocated to each part.

2. Device according to claim 1, wherein several antennas are arranged on the two parts of the processing machine at an at least approximately regular distribution with respect to the peripheral direction of rotation.

3. Device according to claim 1, wherein the individual antennas arranged on the same part of the processing machine have the same shape relative to each other and are offset in the peripheral direction by an angle that equals at least approximately 360° divided by the number of antennas.

4. Device according to claim 1, wherein the lengths of the individual antennas overlap in the peripheral direction of rotation and the individual antennas are arranged at least partially offset with respect to each other radially and/or in the longitudinal direction of the rotational axis.

5. Device according to claim 1, wherein in-phase signals are fed from the transmit device to the individual antennas, and signals received from the individual antennas are superimposed in-phase with each other by the receive device.

6. Device according to claim 1, wherein phase-shifted signals are fed by the transmit device to the individual antennas, and/or signals received by the individual antennas are superimposed phase-shifted with each other by the receive device.

7. Device according to claim 6, wherein the phase shift is at least approximately 360° divided by the number of antennas.

8. Device according to claim 2, wherein the individual antennas arranged on the same part of the processing machine have the same shape relative to each other and are offset in the peripheral direction by an angle that equals at least approximately 360° divided by the number of antennas.

9. Device according to claim 2, wherein the lengths of the individual antennas overlap in the peripheral direction of rotation and the individual antennas are arranged at least partially offset with respect to each other radially and/or in the longitudinal direction of the rotational axis.

10. Device according to claim 2, wherein in-phase signals are fed from the transmit device to the individual antennas, and signals received from the individual antennas are superimposed in-phase with each other by the receive device.

11. Device according to claim 2, wherein phase-shifted signals are fed by the transmit device to the individual antennas, and/or signals received by the individual antennas are superimposed phase-shifted with each other by the receive device.

12. Device according to claim 11, wherein the phase shift is at least approximately 360° divided by the number of antennas.

13. Device according to claim 3, wherein the lengths of the individual antennas overlap in the peripheral direction of rotation and the individual antennas are arranged at least partially offset with respect to each other radially and/or in the longitudinal direction of the rotational axis.

14. Device according to claim 3, wherein in-phase signals are fed from the transmit device to the individual antennas, and signals received from the individual antennas are superimposed in-phase with each other by the receive device.

15. Device according to claim 3, wherein phase-shifted signals are fed by the transmit device to the individual antennas, and/or signals received by the individual antennas are superimposed phase-shifted with each other by the receive device.

16. Device according to claim 15, wherein the phase shift is at least approximately 360° divided by the number of antennas.
